(19) United States
(12) Patent Application Publication
(10) Pub. No.: US 2009/0266901 A1
(43) Pub. Date: Oct. 29, 2009

(54) Souvenir Creation Method and Product

(76) Inventors: Gulzade Dinc, McLean, VA (US); Bulent Dogan, McLean, VA (US)

Correspondence Address: General Counsel, P.C., 6862 Elm Street, SUITE 800, McLean, VA, 22101, US

(21) Appl. No.: 12/110,376

(22) Filed: Apr. 28, 2008

(51) Int. Cl. G06K 19/06

(52) U.S. Cl. 235/493

(57) ABSTRACT

A process for creating a souvenir from an access card is disclosed. The access card includes a source depiction surface bearing a source depiction and may include an embedded magnetic material or an externally affixed magnetic material. The access card is capable of display on a display surface such that the source depiction is oriented in the direction of a bystander.

### FIELD OF THE INVENTION

The present invention relates to the field of souvenir creation and more specifically to the field of access card manipulation.

### BACKGROUND

There was once a time when a guest checked in to a hotel that the hotel would provide the guest with a traditional entry key, similar those that fit in the lock of a house door. Guests would frequently lose those traditional keys, often unwilling to place them on their key chains, perhaps thinking that a keychain was meant only to house more permanent keys, or the guests might accidentally take them home. Replacing keys and the locks that accept them was expensive and time consuming. The introduction of the hotel card keys and electronic data incorporation thereon obviated the need for physical keys and their commercial baggage. Card keys are reusable, quicker to replace, and allow a hotel a separate vehicle upon which to include advertising, marketing, or creative expression.

Card keys utilize simple technology. A blanked key card receives information from a central computer system. That information includes a checkout date and random selection of numbers corresponding to an access code. The access code is typically restricted to allow only entry into a room and sometimes locked areas which are shared by all hotels guests. The checkout date exists to allow the card to stop working when the guest leaves.

Guests no longer require a lengthy check out process that demands a key return. The guests may bypass the front desk for the sake of efficiency or simply to retain the keycards as a souvenir from the stay in the hotel. It is a common site for a business traveler to have a displayable collection of hotel key cards.

Therefore, there is a need for a process that imbues marketing upon an access card with a longer life and a need for an access card amenable to simple, quick, prominent display upon a myriad of surfaces.

### SUMMARY

The present invention is directed to a method and products for prolonged market exposure and souvenir display. As access cards, such as those distributed at a hotel, have little functional use after the data within has expired, they are frequently discarded. As the access card is abandoned, the marketing material on the face of that card lost. The present invention includes a process for creating an access card souvenir for a customer and an access card souvenir product.

The access card souvenir includes an access card body and a magnetic material. The access card body has a source depiction surface that includes a source depiction. A source may be any indicator of location, provider of a good, provider of a service, etc. Behind the source depiction surface is an aft surface, and the spanning the access card body is a body periphery. Furthermore, the body stores the entry data for actuating a lock. The magnetic material, when activated and/or affixed to the access card, is capable of releasably adhering the body in a self-supporting manner to a ferromagnetic display surface.

Preferred embodiments of the present invention include a hard magnetic material upon the aft surface, or a hard magnetic material in a dormant state embedded within the access card body. When the magnetic material is affixed to the aft surface, a preferred configuration positions the magnetic material such that it is invisible to a viewer viewing the access card from the point of view facing the source depiction surface, for example, by spacing the magnetic material from contact with the periphery of the access card body. Although either soft or hard magnetic materials may be used, the preferred magnetic material is a ferromagnetic material.

The process for creating a souvenir for a customer includes distributing the access card of the present invention to a customer. The access card is conducted to a magnetizer, and is magnetized by the magnetizer in a self-supporting manner. The magnetized access card is returned to the customer who may display the magnetized access card on a substantially planar display surface amenable to magnetic interaction with the magnetized access card souvenir. The process of the present invention is applicable to access cards bearing either an internal or external magnetic material.

Therefore, it is an aspect of the present invention to present a process capable of perpetuating the longevity of marketing displayed on an access card.

It is a further aspect of the present invention to present a process capable of effectively creating souvenirs from functional items.

It is a further aspect of the present invention to present a process capable of creating inexpensive souvenirs.

It is a further aspect of the present invention to present an access card capable of functional use prior to transitioning the access card to a display item.

It is a further aspect of the present invention to present an access card capable of effective, releasable affixation to common surfaces.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is an upper, perspective view of an access card of the present invention.

FIG. 2 is a lower, perspective view of an access card of the present invention.

FIG. 3 is an exploded view of an access card of the present invention.

FIG. 4 is a rear, plan view of an access card of the present invention.

FIG. 5 is a front, plan view of a display mat of the present invention.

FIG. 6 is a side, plan view of a display mat of the present invention.

FIG. 7 is a cut-away view of an access card of the present invention.

FIG. 8 is a perspective view of the access card contacting a display surface.

FIG. 9 depicts a method of the present invention.

FIG. 10 depicts a method of the present invention.

FIG. 11 depicts a method of the present invention.

### DETAILED DESCRIPTION

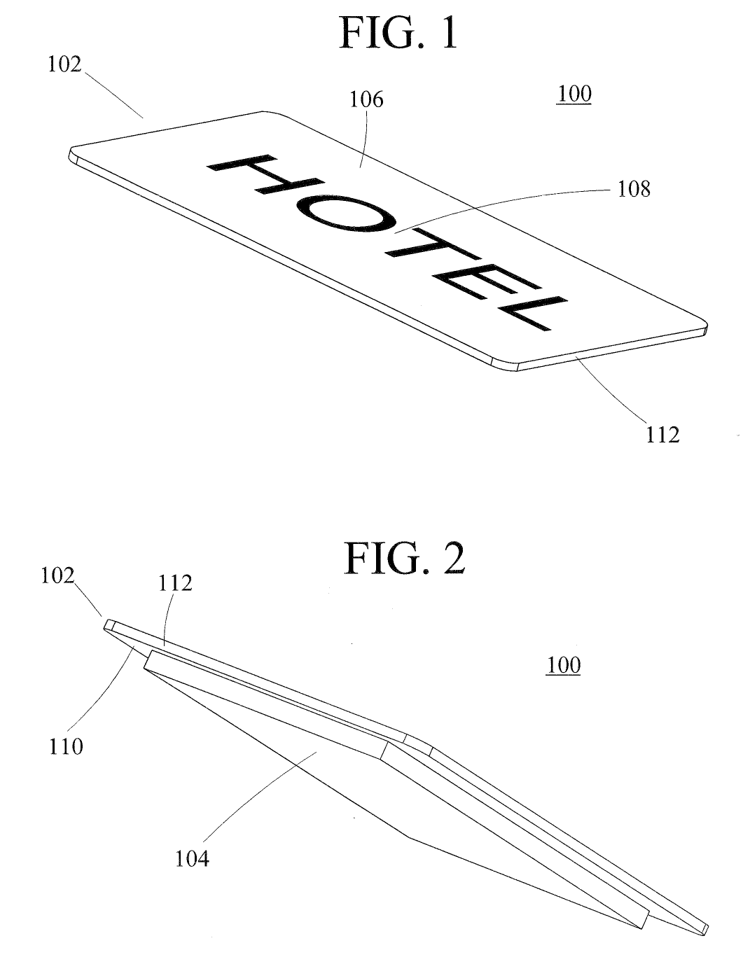

Referring first to FIGS. 1 and 2, an embodiment of the access card souvenir 100 is shown. The access card souvenir 100 includes an access card body 102 and a magnetic material 104. An access card includes any device capable of unlocking a portal via non-physical means. Preferred access cards include planar key cards adapted to unlock doors on vacation abodes.

The access card body 102 has at least one source depiction surface 106 with at least one source depiction 108. The access card souvenir 100 may include one or more source depiction surfaces. The source depiction 108 indicates the source of any location, provider of a good, provider of a service, etc. Preferred source depictions include a festival indication, a hotel indication, a cruise indication, natural and historic attractions, and events such as conferences, concerts, anniversaries, casinos, etc. Behind the source depiction surface 106 the access card body 102 may include an aft surface 110. The aft surface 110 is preferably a planar surface. Circumscribing the access card body 102 is the body periphery 112. Within or upon the body 102 is contained entry data for actuating a lock on a portal. Typical entry data includes a random selection of numbers and a check out date.

The magnetic material 104 of the present invention may include either a soft magnetic material or a hard magnetic material. The choice of utilizing a soft or a hard magnetic material depends on the magnetic permanence desired to be applied to the access card body 102. In circumstances where a permanent magnet is preferred, a hard magnetic material may be used; in circumstances where temporary magnetization is preferred, a soft magnetic material may be use. Preferred hard magnetic materials include ferromagnetic materials, such as iron (Fe), nickel (Ni), cobalt (Co), gadolinium (Gd), and alloys and mixtures comprised thereof. It is most preferred that magnetic materials typically employed in the creation of refrigerator magnets are used as the magnetic material of the present invention, e.g. ceramic magnets comprising a composite of iron oxide and barium/strontium carbonate.

Embodiments of the present invention may include dormant magnetic materials or active magnetic materials. An active magnetic material is a magnetic material initially capable of substantial magnetic interaction with another magnetic material without further activation or magnetization. Substantial magnetic interaction for the purposes of this disclosure includes a magnetic attraction capable of supporting the access card body 102 upon a common ferromagnetic display surface of substantial size. A substantially-sized display surface is a surface having a periphery size comparable to, or larger than, that of the access card body 102. Common ferromagnetic display surfaces include kitchen appliances such as refrigerators and dish washers, and metallic surfaces such as file cabinets, doors, window frames, etc.

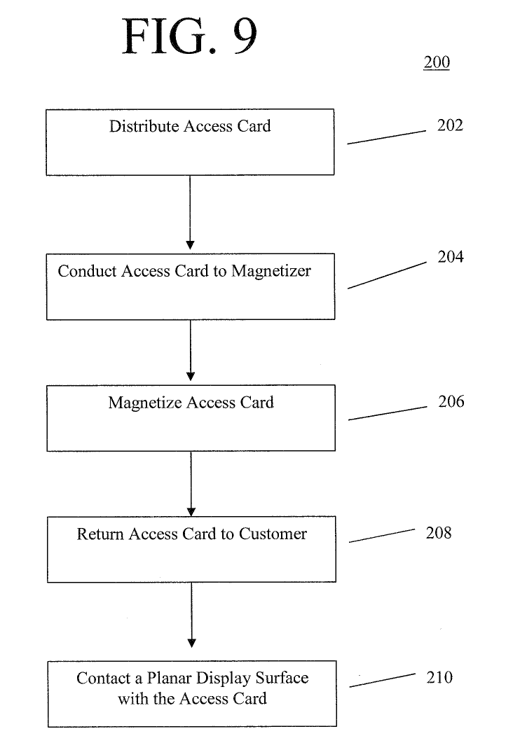

With reference to FIG. 9, a preferred process 200 of the present invention includes distributing 202 the access card to a customer for uses related to the access card entry data. Uses related to the access card entry data may include unlocking a domicile door or gaining entry to other locations selectively impeded by a barrier. When the customer has finished using the access card, s/he may return the access card to a clerk affiliated with the entity that initially distributed the card (or other entity) or use a device adapted to allow independent creation of the access card souvenir. The access card would then be conducted 204 to a magnetizer which would then magnetize 206 the access card to create the access card souvenir of the present invention. The access card souvenir would then be returned 208 to the customer who may then display the access card souvenir upon a substantially planar ferromagnetic surface by mere contact 210.

The access card may be conducted directly to the magnetizer by a customer, or the access card may be conducted to an intermediary, such as a clerk or other employee affiliated with the organization that distributed the access card, who may then directly conduct the access card to the magnetizer. In instances where the access card is conducted directly to the magnetizer by a customer, it is preferred that the magnetizer be available to multiple customers in a common area and bear instructions, or some other interface, that assist a user in independently operating the magnetizer without the assistance of another. A common area may include any location freely accessible to a customer for a period of time related to creating the access card souvenir of the present invention.

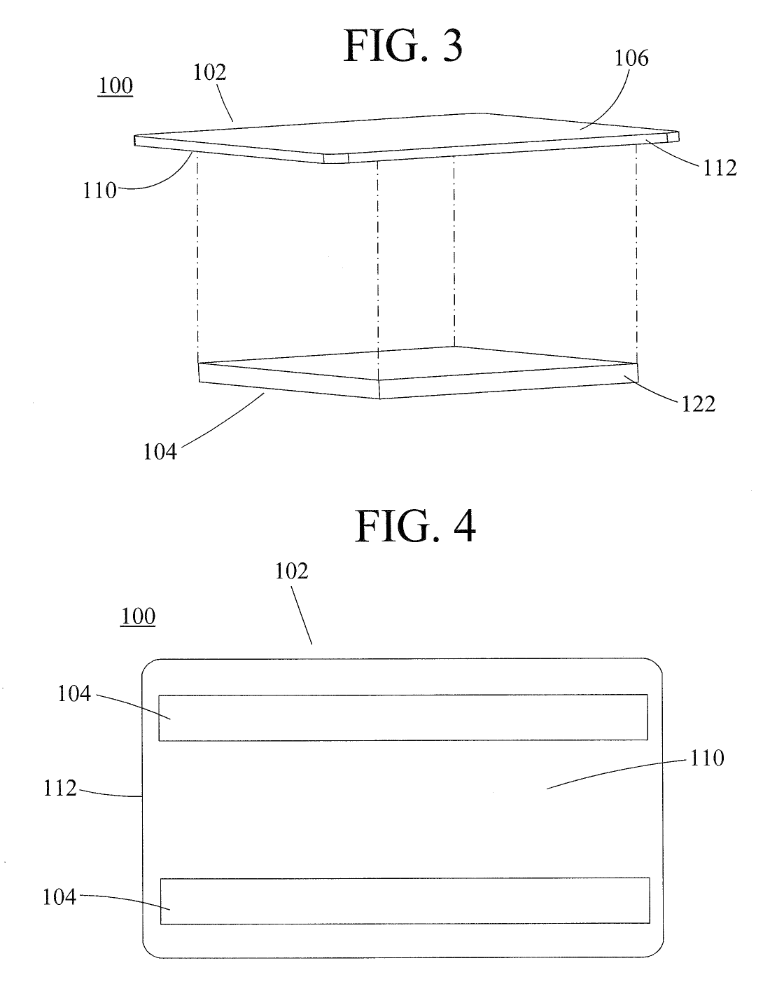

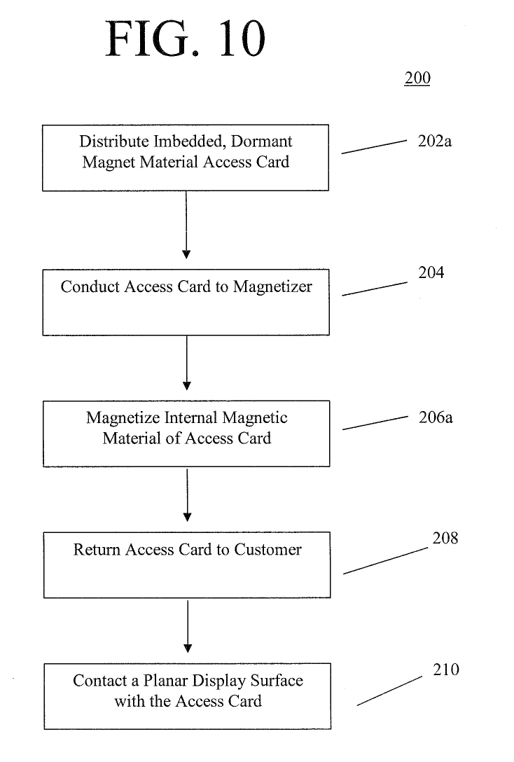

FIG. 3 illustrates an embodiment of the present invention that utilizes the magnetic material 104 in exterior affixation to the aft surface 110 of the body 102. It is preferred that the magnetic material 104 include a hard magnetic material that is initially activated. With reference to FIG. 10, it is preferred that the access card is distributed 202 to a customer in its native form, i.e. unencumbered by magnetization unrelated to the access card entry data or other magnetic fields incapable of substantial magnetic interaction. The access card body 102 would then later acquire an external magnetic material 104 affixed 206b on the aft surface 110 at some point in time after distribution, presumably when the access card is no longer needed by the customer. The magnetic affixation 206b may occur through the aid of existing magnet affixation devices such as those sold under the brand name XYRON, e.g. XYRON 510 Machine, modified to accept access card 100 dimensions. As FIG. 3 further shows, it is preferred that any magnetic material 104 affixed to the aft surface 110 of the body 102 include a magnetic material periphery 122 having a perimeter smaller than the perimeter of the body periphery 112. The periphery perimeter differential ensures that a bystander to the access card souvenir 100 in its display state cannot view the magnetic material 104, which in its native state would likely not be considered decorative.

As FIG. 4 shows, there is not a preferred dimension or configuration of the magnetic material 104 other than that relating to differential perimeters. The magnetic material 104 may include a single solid block, one or more strips, or any other dimensions or configuration that accomplishes the objectives of the present invention. It is preferred that the magnetic material 104 is adhered to the aft surface 110 with a bonding agent suitable to affix the magnetic material 104 to the aft surface 110 for a period of time suitable to souvenir display.

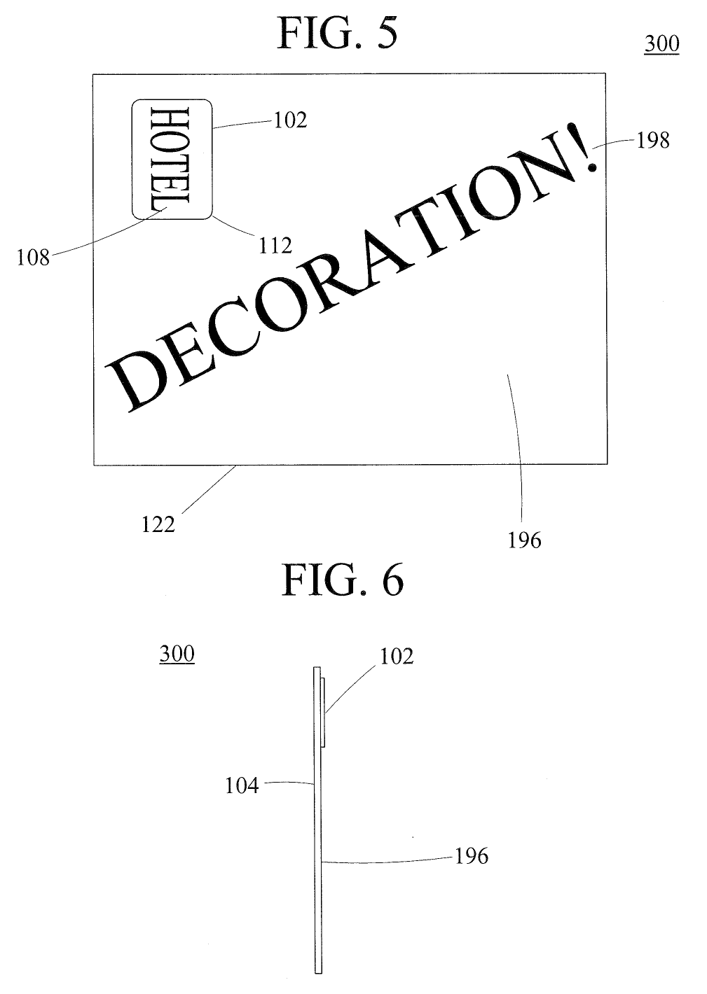

FIG. 5 and FIG. 6 depict a display mat 300 embodiment of the access card souvenir. The display mat 300 includes the access card body 102 of the present invention in conjunction with a magnetic material 104. The magnetic material 104 includes a periphery 122 that is greater than the periphery 112 of the body 102 such that the magnetic material 104, or the material supporting the magnetic material, is visible to an observer viewing the card source depiction surface 106 and source depiction 108. It is preferred that the magnetic material 104 of the display mat 300 embodiment include a mat decoration surface 196 and a mat decoration 198. The mat decoration surface may include that portion of the magnetic material 104 viewable in conjunction with the access card source depiction surface 106, or include a distinct layer covering that portion of the magnetic material 104 viewable in conjunction with the access card source depiction surface 106. It is preferred that the mat decoration surface 196 include a layer of decorated film covering the portion of the magnetic material 104 viewable in conjunction with the access card source depiction surface 106. A mat decoration 198 may be included upon the mat decoration surface 196 to mask the existence of the functional magnetic material 104.

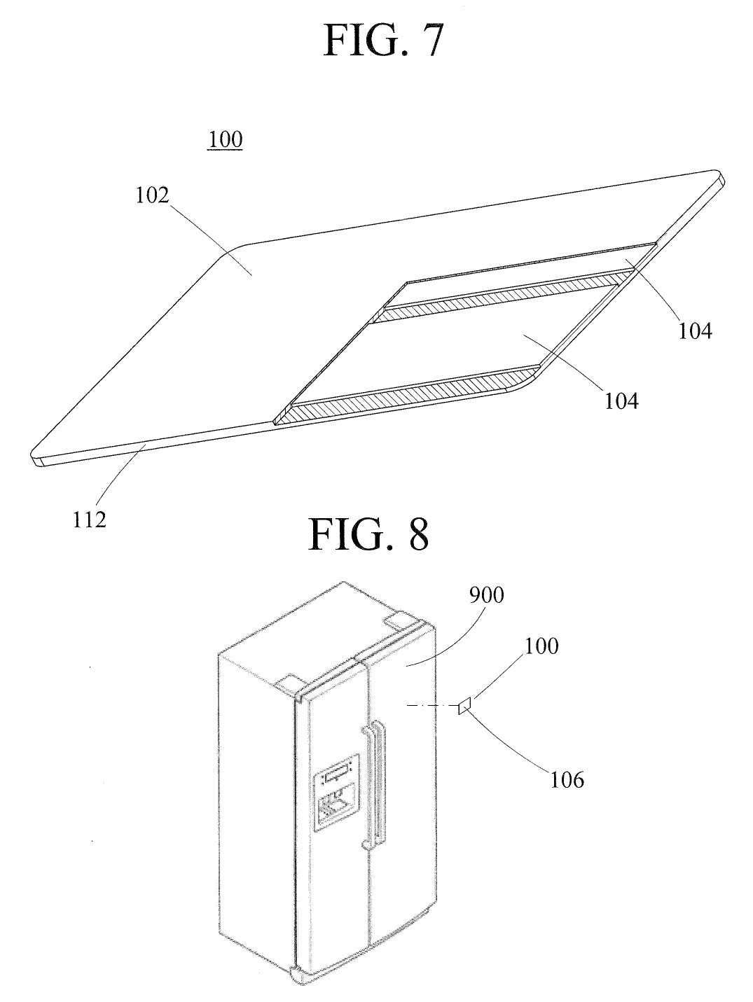

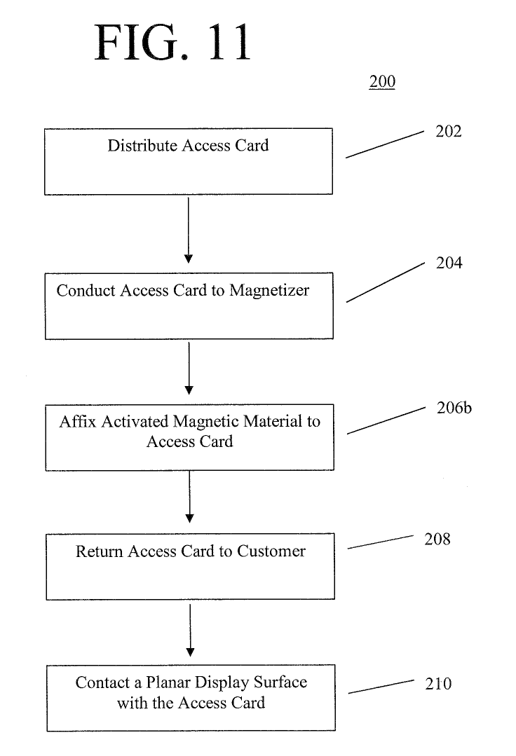

Turning now to FIG. 7 with reference to FIG. 11, the embedded, dormant magnet embodiment of the access card souvenir 100 is displayed. A dormant magnetic material is a magnetic material that is not magnetized upon issuance of the access card 100, but is capable of later magnetization. The dormant magnetic material may include a hard magnetic material or soft magnetic material. A magnetizer may be used to magnetize 206a, or activate, the dormant magnetic material to an active magnetic material capable of substantial magnetic interactions. The magnetizer of the present invention applies a magnetic pulse to the dormant magnetic material suitable to initiate substantial magnetic interaction. The energy of the magnetic pulse will be related to the necessary magnetizing field strength and the size of the magnetic material. The magnetizer of the present invention may include a capacitance discharge magnetizer (CDM), many models of which are available through commonly known suppliers, tuned to the magnetic material 104 used with the body 102.

In use, the access card body 102 may be initially distributed 202a with magnetic material embedded within the access card body 102 to a customer. Alternative embodiments of the present invention may utilize dormant magnetic material on the exterior of the access card body 102. To prevent the magnetic field of the magnetic material 104 from interfering with the magnetically affixed data of the access card body 102, the magnetic material 104 displays insubstantial magnetic qualities. Insubstantial magnetic qualities for the purpose of this disclosure include a magnetic field incapable of interfering with the recognition of the access card entry data by a lock mechanism.

As FIG. 8 shows, the magnetized access card souvenir 100 may be displayed by contacting 210 a substantially planar display surface 900. The display surface 900 of the present invention is any surface commonly used to display items. The display surface 900 is preferably substantially planar in that it is dimensioned to accommodate the generally flat dimensions of the access card body 102.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A process for creating a souvenir for a customer, said process comprising:
distributing to the customer an access card with a body having a source depiction surface bearing a source depiction, an aft surface behind said source depiction surface, a body periphery, and portal entry data;
conducting said access card to a magnetizer;
self-supportingly magnetizing said access card with said magnetizer to create an access card souvenir;
returning said access card souvenir to the customer; and
contacting a substantially planar display surface amenable to substantial magnetic interaction with said access card souvenir.

2. The process of claim 1 wherein said self-supportingly magnetizing step includes affixing a magnetic material upon said aft surface.

3. The process of claim 2 wherein said affixing step includes affixing said magnetic material upon said aft surface such that said magnetic material does not contact said body periphery.

4. The process of claim 1 wherein said distribution step includes distributing said access card with an embedded magnetic material.

5. The process of claim 4 wherein said distribution step includes distributing said access card with a dormant, hard magnetic material.

6. The process of claim 4 wherein said distribution step includes distributing said access card with a dormant, soft magnetic material.

7. The process of claim 1 wherein said distribution step includes distributing said access card with a hard magnetic material having insubstantial magnetic interactions and capable of activation to instill substantial magnetic interactions.

8. The process of claim 1 wherein said conducting step includes conducting said access card to a magnetizer, located in a common area of a commercial establishment, having a consumer interface adapted to instruct said customer in the independent operation of said magnetizer.

9. The process of claim 8 further comprising the step of requesting currency from a consumer.

10. An access card souvenir comprising:
an access card body with a periphery, portal entry data, and a source depiction surface bearing a source depiction; and
a dormant magnetic material, embedded within said body, adapted to releasably adhere said body in a self-supporting manner upon activation to a ferromagnetic substance through substantial magnetic interactions.

11. The access card souvenir of claim 10 wherein said magnetic material includes a hard magnetic material.

12. The access card souvenir of claim 11 wherein said magnetic material includes a ferromagnetic material.

13. The access card souvenir of claim 10 wherein said magnetic material includes a soft magnetic material.

14. An access card souvenir comprising:
an access card body with a source depiction surface bearing a source depiction, an aft surface behind said source depiction surface, a body periphery, and portal entry data; and
a dormant hard magnetic material, affixed to said aft surface, with a magnetic material periphery and adapted to releasably adhere said body in a self-supporting manner to a ferromagnetic substance.

15. The access card souvenir of claim 14 wherein said magnetic material includes a ferromagnetic material.

16. The access card souvenir of claim 15 wherein said magnetic material is affixed upon said aft surface such that said magnetic material does not contact said periphery of said body.

17. The access card souvenir of claim 16 wherein said magnetic material periphery is larger than said body periphery such that said magnetic material extends beyond the body periphery of said body.

18. The access card souvenir of claim 17 wherein said magnetic material includes a decoration surface having a decoration thereon and sharing a visual orientation with said source depiction surface.

19. The access card souvenir of claim 18 wherein said magnetic material includes a distinct decoration surface.

20. The access card souvenir of claim 19 wherein said distinct decoration surface includes a film layer bearing said decoration.
